(19) United States
(12) Patent Application Publication
(10) Pub. No.: US 2007/0035059 A1
(43) Pub. Date: Feb. 15, 2007

(54) Method for manufacturing injection-moulded plastic products and an integrated upgrading system

(76) Inventor: Jari Ruuttu, Billstensvagen (FI)

Correspondence Address: YOUNG & THOMPSON, 745 SOUTH 23RD STREET, 2ND FLOOR, ARLINGTON, VA, 22202, US

(21) Appl. No.: 10/578,098

(22) PCT Filed: Nov. 10, 2004
(86) PCT No.: PCT/FI04/00666

§ 371 Date: Aug. 4, 2006

(30) Foreign Application Priority Data
Nov. 11, 2003 (FI) 20031634

(51) Int. Cl. B29C 45/14

(52) U.S. Cl. 264/132; 264/259

(57) ABSTRACT

Method for manufacturing injection-moulded plastic products, in which method an IM film is used, which travels continuously through several work steps known as such, in which the IM film is processed so that a desired image, text or some other desired design is achieved onto it. The processed IM film is then directed to the injection moulding process, in which the product and the IM film are combined, after which the combination is transferred onto a platform or, for example, directly to the assembly line of mobile phones in an integrated upgrading system.

This invention (later colochrome) comprises a manufacturing method, in which an IM (in mould) film is led to an injection moulding unit after selected work processes, in which unit the physical end product with finished surfaces will be formed. After this, the selected work processes are conducted for achieving a complete commercial end product.

The colochrome method of the invention is a completely independent production unit, in which all necessary upgrading methods are integrated as a unity, in which all steps are synchronised with each other, i.e. the product to be manufactured need not be taken elsewhere for upgrading, but all the steps for achieving the desired workpiece can be realised in the said colochrome production unit.

It is characteristic of the colochrome method that it is fully flexible, i.e. it has no pre-defined productional interface, and a decision on the design needs to be made only about 35 seconds before the injection moulding of the workpiece.

When examining present consumer goods and marketing mechanisms related with these it is stated that the decision-making process on the design of the product has to be left later and later, and it will change many times during the lifecycle and manufacturing process of the product.

Typical such consumer goods are electronics products, such as mobile phones, wrist watches, CD players, portable PCs, etc.; furnishing parts used in the car industry, electric sockets, and switches, etc.

The invention will be next explained by means of mobile phones.

The manufacturers of mobile terminals (later terminal) operate in markets, in which the technical properties of the product, the design of the product, and its quality have a great significance for commercial success.

In the manufacture of terminals, only a few design variations have been used, and the cover of the terminal has been painted with a protective colour only.

This invention, the colochrome method, next presents the solutions, which improve the surface quality of the product, make the production process considerably faster, lower the production costs. In addition, the method is fully flexible.

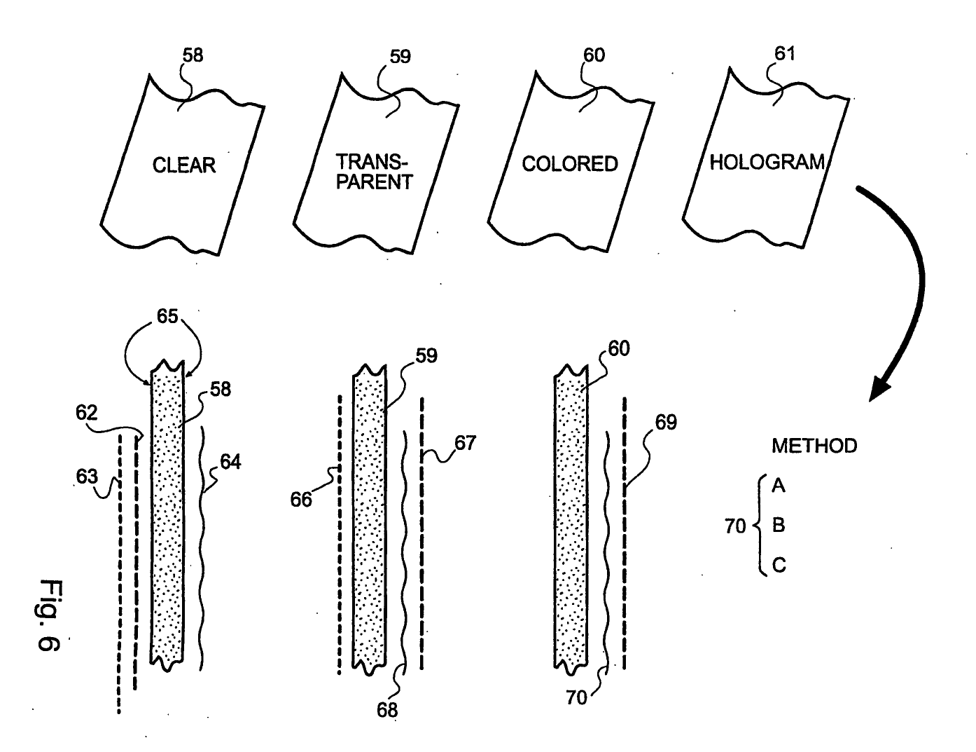

The colochrome method is based on the use of an IM film (FIGS. 6; 58, 59, 60 and 61), selected for each purpose in question. It is essential that the films are clean, i.e. they have not been processed in any way.

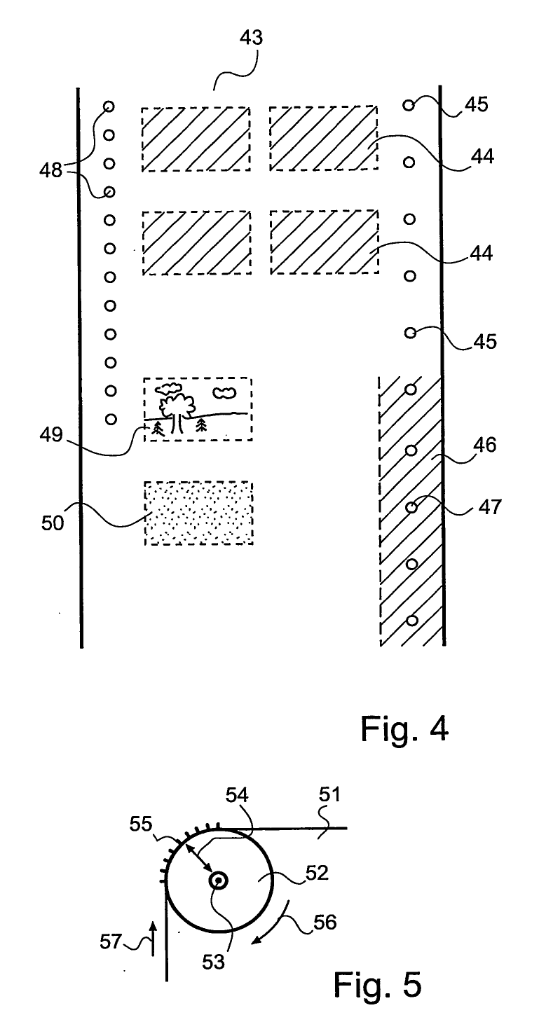

The IM film forms part of the product, i.e. it stays as the outer surface of the workpiece in the injection moulding process, simultaneously forming the conveyor. Thus, the IM film is uniform, and the transfer between different work processes is made by means of it. In this case, the IM film can have perforated points (FIG. 4; 48, 45) or a strengthened edge 40, which assist in the transfer, e.g. by means of a cog-wheel (FIG. 5; 54).

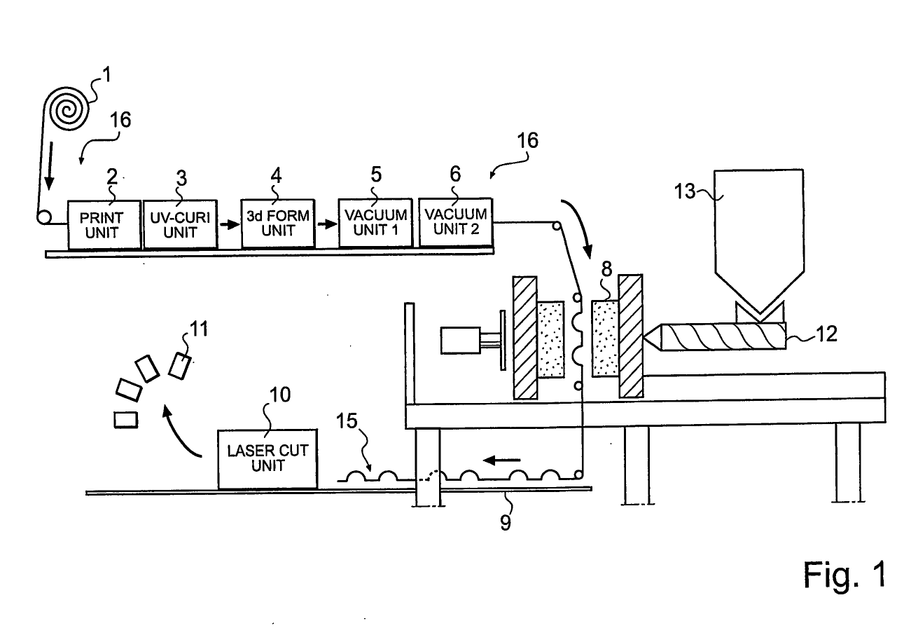

The most difficult work processes, such as forming the image (FIG. 4; 49) by piezo printing or laser printing, and the hard coating of the outer surface by a UV hardened lacquer is performed when the IM film is still straight and unprocessed (FIGS. 1, 2 and 3). Three-dimensional surfaces can be achieved onto the film by a laser engraving method.

FIG. 1 discloses the basic diagram of the colochroine method, to which all steps related with the upgrading have been placed: (2) the image formation and laser engraving step, (3) the surface lacquering and UV hardening step, which are performed before the 3d formatting step (4), after which the vacuum coating steps 5 and 6 will be performed for achieving the effect colours, metal coating, mirror surfaces, etc.

Thus, an IM film in 3d format, with fully finished surface and properties, has now been formed, the film then being transferred to the injection moulding step 8, after which a fully finished cover will come out, which still is part of the IM film band 9 and 1.

After this, RF shielding, screening by a vacuum process can be simply performed before the IM film band 1, 9 is transferred to the laser step 10, in which the apertures and holes will be cut open before detaching the workpiece e.g. by the shown laser from the IM film band. The workpieces 11 are now 1 ready.

It is essential to understand that the IM film 1 is e.g. in the roll form according to the figure and that it is clean, i.e. it has not been processed in advance in any other way than by etching the one or both surfaces, which is a chemical process for achieving a better adhesion of the lacquer or printing ink, or by making a perforation which relates to the transport of the film from one work point to another, but these are as such not related with the formation of the product or the surface in any way, but they are auxiliary means.

FIG. 1; 5 are vacuum processes, in which colour can be achieved over the extent of the whole spectrum, as reflecting, metallic, oxides and inert gases.

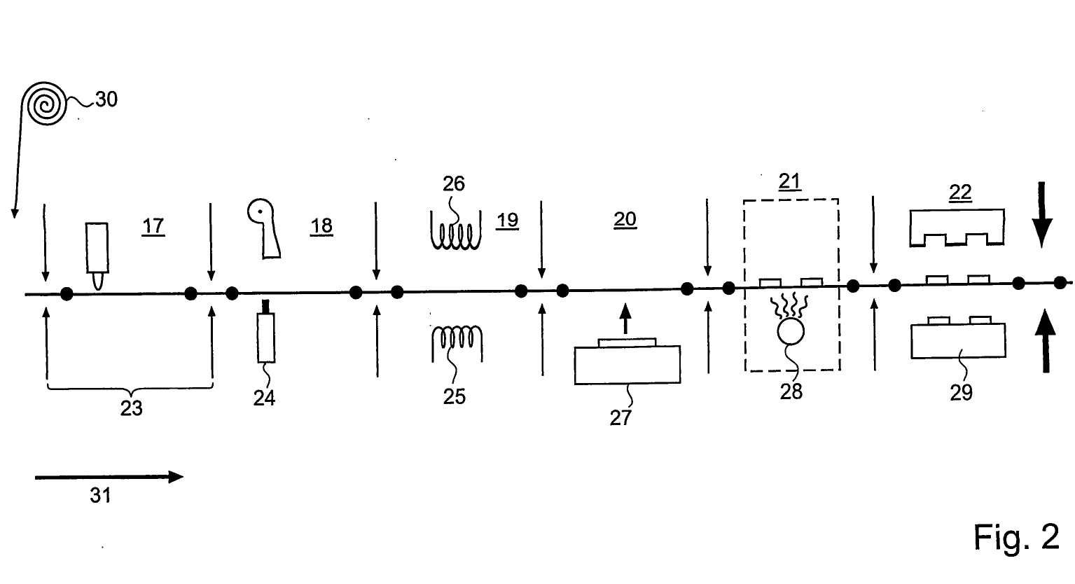

Likewise, FIG. 1; 2, FIG. 2; 17 disclose the hard coating of the IM film 32 by lacquer substrates, a piezo spray/priott head, connected e.g. 4 in a row for achieving a larger coverage base.

In the colochrome method it is common to all the steps that they are digitally controllabe and that each step, which relates to the formation of a visual surface, forms independently a very big possibility to vary the design, but which combined, the range is practically unlimited.

Because the basic idea of the invention is that by combining various technologies, steps, which would be directed to the clean IM film and which would be digitally controllable, the number of surfaces would thus be unlimited and the full flexibility of the manufacturing method would be granted without having to do anything mechanically. Only as the production piece/workpiece is new the moulds of the IM film will naturally be changed from the 3d formatting station (FIG. 1; 4) and likewise the moulds from the injection moulding machine 8.

This invention, the colochrome method, in which different steps are integrated to work together in a syncronised way, also has such effects on the quality of the work that could not be achieved as separate steps. Examples are the tasks of the IM film 43 in FIG. 4, the printing of the image 49 and the hard coating of the surface 50, which in this invention can be realised with a better end result concerning costs and quality.

FIGS. 2 and 4 disclose the places where the outer surface of the IM film 32 has been placed into an exactly defined area.

As the said IM film (32) is transferred to the next work point 18 (drying of the lacquer), a piezo printing or laser printing 24 is simultaneously made onto the lower surface of the IM film 32, in which it is advantageous for the step, if both the coatings have been made by a UV hardening printing ink/lacquer.

Because the next working point 19 contains the UV sources 25 and 26, by means of which both the surface lacquer and the printed image on both sides of the IM film 32 will be hardened, it is essential and new that, in the same connection, the IM film 32 will warm up so much that it can be 3d formatted in the next working point 20.

What has been disclosed above is technologially revolutionary for the reason already stated, but performing the work directly onto the surface and by performing the 3d formatting within a certain time period before the crystallisation of the lacquer/printing ink makes possible the perfect image quality and the forming of the hard coating from the 2d format to the 3d format in a form of extremely high quality, because the printing ink and the surface lacquer are elastic before the crystallisation. The achieved elasticity in the surface lacquer and in the result of the image made into the 2d format, which is technically very easy, is just the property which makes possible the perfect quality also after the 3d formatting.

For achieving a perfect image from the changes by means of the colochrome method of the industrial process, it will next be compared with present production methods.

The production methods used at present differ substantially from the colochrome method already in the operating principle. They function so that the different work processes are conducted elsewhere and they will only be “joined” together with the physical 3d cover in a certain step.

### EXAMPLE 1

The present procedure is based on the principle that IM film will be manufactured in a large amount with images and surface lacquers in the final form, which will then be delivered to the customer in the form of a roll, who will then place the IM film roll onto an injection moulding machine, from which the IM film will be directed to the injection moulding process itself through a deep drawing process.

There are two different procedures in the use of the IM film. The one is that the IM film with a printed text, image and colour, only functions as their transfer base/film to the injection moulding process, in which the image, text, etc. will adhere to the workpiece, but the IM film will not.

In this case the IM film has first been waxed, primed on its surface, and the printing work is performed onto the wax surface using as many layers as is necessary. The heat in the injection moulding process makes the IM film detachable from the wax surface, because its adhesion is naturally much smaller than the surface, in which the printed product is found.

The second procedure is the one, in which the ready printed IM film stays as part of the end product. It differs from the one mentioned above in that wax is naturally not used at all, because now one wants as good an adhesion as possible between the printed product and the IM film. Otherwise the work process itself is the same, likewise the printing process, which is directed to the IM film itself.

The first problem is related to the properties of the printing ink and the surface lacquer, because they crystallise within a certain time, which natural, because diluents evaporate and a reaction occurs with the surface of the IM film irrespective of whether it concerns a UV light, heat or air hardening printing inks or lacquers/paints.

The problem lies just in that the elasticity is almost non-existent after the crystallisation, i.e. the stabilisation, but when the use of the IM film is considered, 3d formatting is conducted, which would require very good elasticity to keep the image/surface right and of good quality.

Because the elasticity is slight or non-existent, printing ink and lacquer/paint will crack and break in the 3d formatting, and therefore, the quality will become substantially poorer.

In a vacuum process, in which metal oxides, silicon oxide, etc. are used, this cannot be applied at all, beause they disintegrate into uncontrollable parts in the 3d formatting; i.e. they can be used only in such a way that has been presented in the colochrome method, i.e. to a finished 3d-processed workpiece.

It is obvious that it is much easier and more cost-efficient to perform the printing process and surface lacquering/painting onto a smooth straight 2d surface, such as an IM film, as occurs in the colochrome method, but this concerns the time function and the order of steps, which requires that all steps be integrated in a synchronous form; otherwise there will be problems as has been shown in the use of the present IM films.

A second problem relates to the consequences that are due to the present manufacturing methods and use of the IM film.

As was said before, the terminal is a design product, i.e. quality and sophisticated appearance is required of the surfaces, and also perfect flexibility in production, because the design changes constantly.

Thus the operational model, in which IM film has been manufactured in advance and then later delivered to the manufacturer of the said product, who manufactures the final physical product, does not work.

First of all, the time delay is altogether too big; generally it takes about a month or a couple of months from the beginning of the manufacture of the film before it is even possible to manufacture the end product, and a month or a couple of months also passes before the necessary number of, for example, cover parts are ready to be delivered and installed to the terminal manufacturer.

The present markets operate in such fast cycles that one has to be able to react real-time; otherwise one will manufacture products that nobody wants. This concerns the so-called standard coves; in “one-of-a-kind” covers, the reaction time is minutes, i.e. the present mode of production, in which it has been necessary to decide on the design months in advance, is no more functional.

As presented earlier, the matter alone that the printing, lacquering or painting process has been conducted earlier, leads to it that crystallisation has taken place in the said coatings so that their elasticity has been lost. Upon heating and 3d formatting, the said surface will break/crack so that the quality and design will no longer be acceptable. When there further exists the said time delay between the film manufacture and the end product and when it further is taken into account that it is impossible to manufacture “one-of-a-kind” products and to use special effects, such as laser engraving, vacuum coating, piezo/laser printing, the present manufacturing method is no longer competitive, neither in quality nor technique.

On a general level one should also try to integrate other essential and necessary steps, such as RF shielding. Otherwise, it is again necessary to transport the workpiece out from the production process, just as at present, which again takes time and costs immensely. This problem field will be described next as part of the logistics and the manufacturing method.

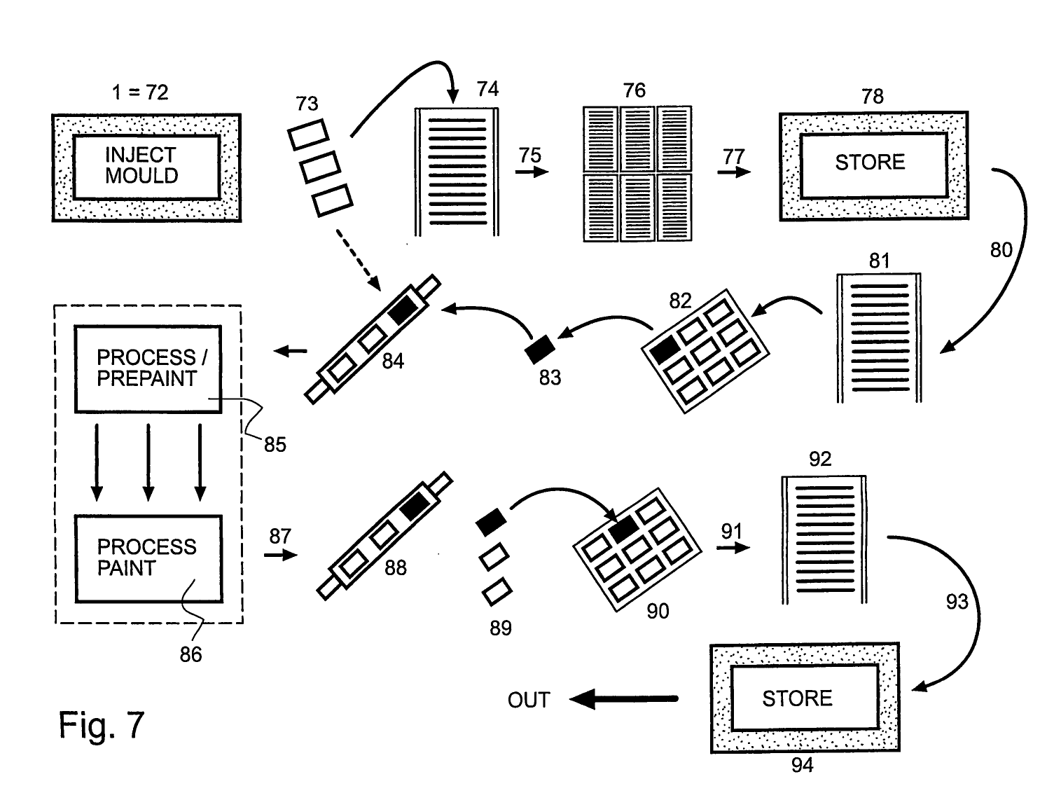

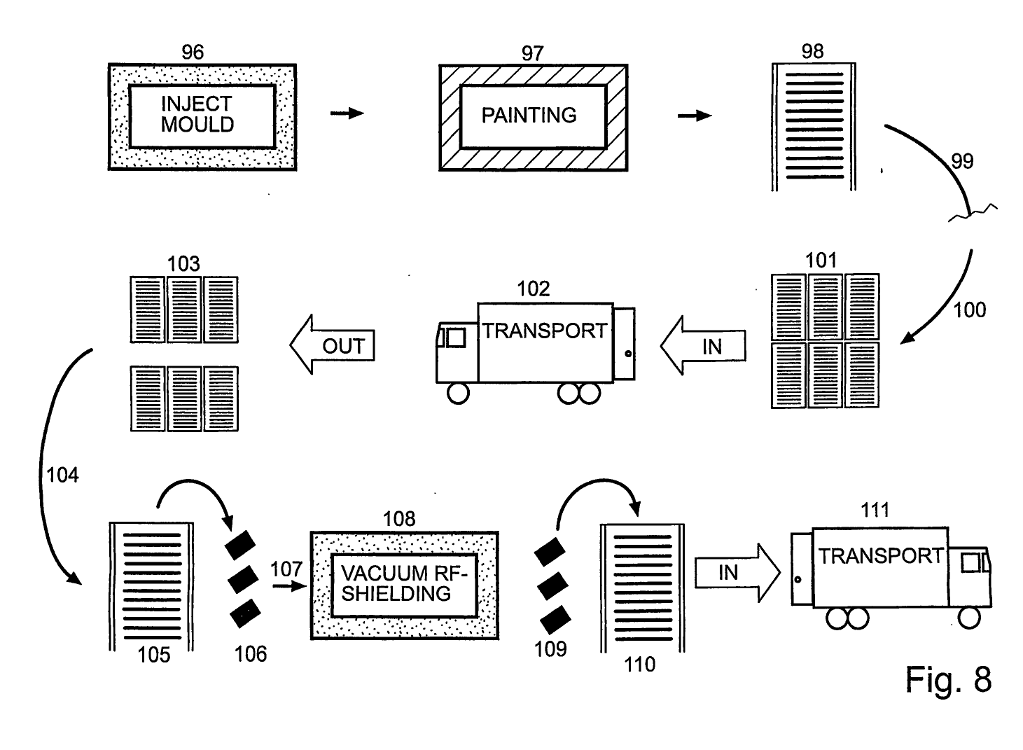

FIGS. 7 and 8 present the prevailing current situation. FIG. 7 discloses the manufacturing process of an injection-moulded workpiece of plastics, e.g. a mobile phone cover, and the related logistics, as the step comprises the painting of covers.

FIG. 8 shows the logistics in the production, in which the workpiece has to be screened (RF shielding) by a vacuum process, which is the only correct way both technically and commercially.

The disclosed FIGS. 7 and 8 together or separately show how difficult it is to control the present industrial manufacturing chain, as the industrial manufacturing processes have not been developed to be operational real-time as the colochrome method.

FIG. 7 shows a situation in which a plastic workpiece is formed in the injection-mould process 72, in which the workpiece is placed onto the packaging platforms 82, 90 by using 73 a manipulator or a robot, and it is placed in a transport cart 74, which are then collected 75 in a necessary amount 76 to be transported 77 to the intermediate storage 78.

Upon starting the painting process, each packaging platform 82 placed into the transport cart 81 is discharged so that the workpieces 83 can be placed into the painting jig 84, which generally is purely manual work. The jig 84 are placed onto a conveyor, which takes them to the painting processes, which are priming 85, comprising the intermediate drying, after which the actual surface painting process 80 will be conducted, comprising also at least the air/heat drying. The length of the said work process is some tens of minutes.

As the jig 88 leaves the painting work processes 85 and 86, the workpieces 89 are detached from it and placed again onto the packaging platform 90 that, after becoming fully loaded, is again placed into the transport cart 92, which is taken 93 to the storage 94 to wait for the assembly 95.

It has also been tried to bypass part of the chain 79 described above so that the workpieces 83 are placed directly into the painting jig 84 from the injection moulding process 73, but this requires an extremely large number of painting jigs 84. A flier problem is where to place the workpieces 83, 89 after the painting processes 85, 86.

It has to be noted that the injection moulding process per workpiece is about 15 seconds, but the Mw indicating work processes with waiting periods take at least 40 times this.

Everything that has been described in FIG. 7 can be avoided, if the colochrome method according to the invention is used; especially when the section presenting the lacquering/painting of the IM film by a piezo spray and the 3d formatting are performed immediately after the UV hardening, when the surface lacquer/paint is still elastic.

The painting process disclosed in FIG. 7 is thus performed exactly for the reason that the IM film has been printed and painted in advance, and that it is no more elastic as it is 3d formatted, but it will break.

FIG. 8 presents a situation, which is typical at least with mobile terminals containing radio transmitter/receiver units and processors and other electronics, which requires the workpiece to be screened (RF shielding) by a vacuum metallisation process.

It has to be noted that screening, which is performed by vacuum metallisation to a workpiece, in which the work is conducted by outsiders for reasons that have no significance for the patenting itself, but which is real also globally.

FIG. 8 presents a situation, in which the work processes disclosed in FIG. 7, i.e. the injection moulding 90 and the painting 97 of the workpiece have been carried out and the workpieces have been placed 90 onto packaging platforms, which again have been placed into transport carts 92 placed into the storage 94.

FIG. 8 continues the storing from the point in which the workpieces of different shapes placed into the transport carts 98 are delivered 99, 100 to be transported, for cost reasons generally as full loads 101 into the transport truck 102, which delivers them to the storage 103 of the company performing the work process, in which a cart at a time is unloaded 105 so that the workpieces 106 can be placed onto the RF shielding jigs/platforms.

It is mandatory to place the workpieces for work-technical reasons to the so-called shielding jigs, and these are not the same as the painting jigs in FIG. 7, irrespective of whether a plane vacuum metallisation process or a drum vacuum metallisation process is concerned.

RF shielding, screening by vacuum metallisation, is carried out so that 400-1500 workpieces to be metallised per driving time are placed into a vacuum chamber, and the process usually takes 12-25 minutes a time. Placing the workpieces to the shielding jigs is practically manual work.

Automation is difficult, because the workpieces are different and thus also the jigs needed. Further, new metals appear all the time, i.e. there is no physical shape, thus making the automation difficult.

After the vacuum metallisation process 108, the workpieces 109 are removed from the shielding jigs and placed onto platforms, which again are placed into transport carts 110 and, in order to get the whole transport lot fill, through intermediate storing for final transport 111.

For achieving a clear comparison, FIGS. 7 and 8 present a connection to the use of the IM film in use at present so that the comparison with the invention clearly provides the indication of its effect on the production.

Further, a comparison has been made to the following patent specifications:
WO 00/50212; Method and apparatus for handling workpieces in a manufacturing process
EP 0723 847 A1 Molding apparatus
U.S. Pat. No. 5,539,971
U.S. Pat. No. 19,603,733 A1

The present invention describes the use of the IM film (FIG. 4) as a conveyor according to FIG. 1 so that the IM film forms a continuous film, to which desired work processes, e.g. 2, 3, 4, 5, 6, 16, 8, 15, 10 are conducted in different working points in a predefined order.

Using the IM film as a conveyor is known in the form as it is applied in present use, in which a ready printed IM film is 3d formatted just before the injection moulding process, and by making use of the IM film, the workpiece, which is attached as part of the IM film, is transferred only away from the injection moulding process.

In other words, the difference between the colochrome method of the present invention and any known method, especially taking into account the use of the IM film according to the present practice, is just in that in known methods, no work processes are directed to the IM film in any form, but the IM film is ready printed, i.e the desired work has been performed elsewhere, in a separate work process.

The invention includes work processes with technology levels that can only be performed in an integrated system. In the invention, the IM film is always clean, i.e. no work process has been directed to it before installing it into the machine.

From the manufacturing-technical point of view, the difference is enormous. The limitations of the method of the invention in the manufacture are non-existent, because the IM film is clean when it is transferred to the steps in FIG. 1; in the known methods using the IM film, the IM film is read-y printed (coated), i.e. its limitations are total. Only the product can be manufactured, which has been printed to the IM film in advance.

The present invention and the inventions known now are opposites of each other. With the present invention, any surface can be produced in any order without increasing the costs. The invention is fully flexible, when again only such products can be produced by means of the old known methods, which have been pre-printed onto the IM film, and thus it can not be productive for e.g. “one-of-a-kind” products, i.e. the production process is completely locked, which is the opposite of flexibility.

The invention will next be explained by means of FIGS. 1-6.

FIG. 1 presents the manufacturing method according to the new invention; injection-moulded workpieces, e.g. mobile phone covers. The main principle of the method is that the IM film 1 will be used in the manufacture, the film being clean, unprocessed and most preferably in the form of a roll 1. The method contains the work processes 2, 3, 4, 5, 6, 16 in the desired form before the injection moulding process 8. After this there are the work processes 9 for manufacturing the hologram 15, RF shielding and 6 cutting open by laser.

It is essential for the invention that the said IM film is clean, i.e. it has no affecting steps, because the steps are performed in an integrated manner with the injection moulding method 8 so that all the steps are synchronous.

The clean IM film 1 is transferred to the first step 2, in which the image is printed onto one side of the IM film, and the other side is e.g. painted or lacquered. After this, the said surfaces are hardened by TV light 3, after which and immediately, as long as the surfaces are elastic, i.e. before crystallisation, four (4) 3d formattings are performed.

Steps can be conducted in the vacuum processes 5 and 6, in which metals, oxides, metal oxides, synthetic colouring agents or e.g. coloured silicon oxides (SO₂) are brought onto the surface of the workpiece in a vacuum. In the same connection, laser engraving 10 can be performed, as it can also be performed as the first work process before printing the image 2.

By means of laser it is possible to achieve very sophisticated 3d surfaces and patterns, i.e. certain kinds of holograms, by engraving.

The 3d IM film with a finished design is next transferred to the injection moulding process 8. Plastic is cast against the I film, i.e. at this stage, the workpiece itself is physically in its final form, and it can still be processed 9 before the manufacture of the previous hologram image.

When needed, also screening (RF shielding) can be performed as part of the integrated manufacturing method in steps 15, after which the last step is performed, directed physically to the workpiece and comprising the making of holes or apertures by means of laser and the detachment of the workpiece from the IM film. After this the workpiece 11, which is now complete, can be transferred onto a desired platform or directly to the assembly line.

FIG. 2 shows in a more precise form the work processes shown in FIG. 1, which are performed before the injection moulding methods 22, 29, in which case the lacquering/painting of the outer surface of the IM film is conducted by a piezo spray in the work process 17. There can be more than one (1) spray side by side, for example 2, 4 and 5, etc.

In the next step, the lacquering/painting of the outer surface is air dried 18 and simultaneously produced onto the IM film 32 by a piezo spray/laser printer 24.

After the previous step, the surfaces are hardened by UV light 25, 25 in the work process 19 onto one side or onto both sides of the IM film 32; essentially at the same time as the UV hardening has been performed in the work point 19, so much heating power has been generated that the IM film 32 can be 3d formatted in the working point 20 e.g. by deep drawing 27 immediately during and before the crystallisation (hardening) of the printing/painting/lacquering surfaces, which still are fully elastic, i.e. easily processable.

The 3 formatted workpiece is coated by vacuum technology in the work point 21, e.g. by a batch or sputtering method 28.

The IM film 30 is completely clean and most preferably in the form of a roll, so that it is synchronously fed in the integrated manufacturing method shown, i.e. each work period 23 is of the same length 31.

All steps and the apparatus itself are naturally as a whole in a closed clean room, into which also the injection moulding machine has been placed.

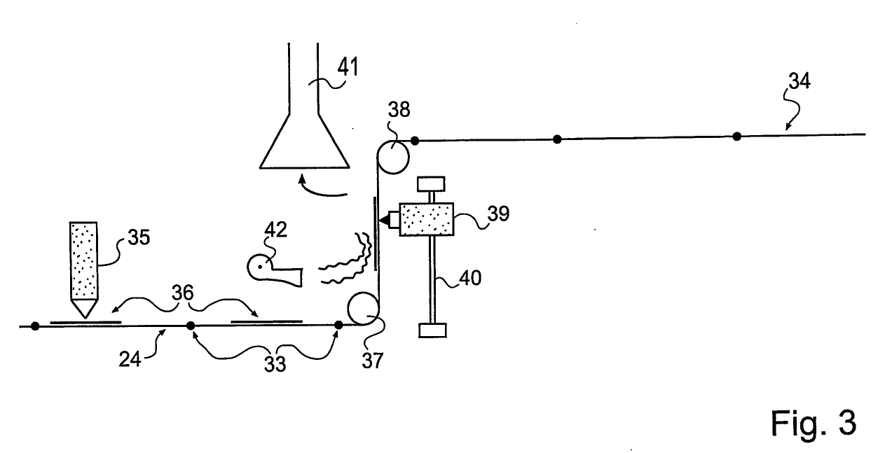

FIG. 3 presents the focused mark of FIG. 2, of the work processes 17, 18, 24, of the coating of the IM film and of the formation of the image. First, the outer surface of the future 3d product is made onto the IM film 34, which has to endure hard wear. The surface is made with UV hardening paints/lacquers or similar.

All steps are scheduled, i.e. their spaces are constant so that it is easy to synchronise the work processes directed to the IM film 34.

Because the IM film 34 is in the normal state, ie. in 2d form, the steps directed to it e.g. the air drying 42 of the lacquer/painting surface 36 are easy to perform simultaneously with the formation of the image 40 x, y onto the opposite side of the IM film 34, i.e. by means of a normal piezo printing device or laser printer 39.

FIG. 3 shows the folding of the IM film 34 with wheels 37, 38 so that the step is technically easy to perform, e.g. in the vertical plane according to the Figure, because otherwise the printing step 39 would have to be performed from beneath, and this is not a good working position.

FIG. 4 shows an example of the IM film 43, which has e.g. the laser engraving 44 with the image 49 printed on it, and with the surface lacquering/painting 50 placed onto the opposite side. All steps can be allocated in the minimum to the accuracy of 1/100 mm. The allocation is facilitated by the precise perforations 45 and 48 in the IM film, or by the strengthened edge 46 with perforations 47.

FIG. 5 presents a situation in which it has been desired to transfer the IM film 51 to a vertical position, e.g. by means of the wheel 52 provided with the cogging 55 so that it can get a good grip of the IM film 51 so that it is possible to transfer 57 the film precisely forwards. For example, a step motor has been connected to the middle shaft 53, in which case the travel of motion 56 is very precise.

FIG. 6 shows different variations of the IM film, which can be applied depending on the purpose of use, and examples of work steps directed to them.

The IM film is a general denomination for a plastic film, the thickness of which is generally 80 μm-250 μm. They are manufactured of PA, PC, PET plastic maerials, etc., which are manufactured so that they can be formatted in a certain temperature.

Thus, the IM films shown in FIG. 6, 58 “clear”, translucent, 59 transparent, i.e. coloured and penetrating light, 60 colores, i.e. tinted and penetrating very little light, are all typical IM films, even though “58” clear is by far the one most used.

The hologram IM film 61 and its different manufacturing modes is a separate chapter, the technology of which will be disclosed later.

The IM films used in the invention and the known methods do not differ from their plastic qualities or other basic characteristics of plastics. The difference is that in the known methods using the IM film the printing work or some other coating process is performed as a separate process in advance, when again in this invention all steps are performed as an integrated part of the injection moulding process.

For example, the surface treatment lacquering (FIGS. 6; 64, 68 and 70), which forms a very hard wear-resistant surface onto the outer surface of the IM film 58, 59, 60, generally refers to a lacquer or paint.

On the technological level the difference is that in the known methods, in which the IM film has been coated in advance, the composition of the coating agent is such that it considerably increases the elasticity, i.e. the composition of the coating agent has been regulated in a desired way in the manufacturing process, e.g. by using a softening agent, or a coating has been chosen, in which elasticity is the basic property of the coating.

Coating agents with very high quality can be used in the invention, which are optically perfect and extremely hard, and the adhesion of which to the IM film is excellent, and which cannot be used in the known IM film methods.

In FIG. 6; 58 there is disclosed a typical IM film, which is transparent and to which differet work processes 64, surface lacquering/painting have been performed in accordance with the invention to the part of the film which form the outer surface of the workpiece. On the opposite side, i.e. the side remaining inside, an image has been formed 62 by piezo printing/laser printer, and after the 3d formatting, this side has been vacuum coated 63 with metal oxides, silicon oxide, or other agents. It has also been suggested that laser engraving 65 can be performed onto one side or onto both sides of the IM film 58 before the said work processes or between the work processes, depending on the desired effect.

FIG. 6 discloses the transparent IM film 59, by means of which it is possible to achieve surfaces with a monochromatic basic colour. When a dyed transparent or clear surface lacquer 38 is used 68, printing work can be made 67 onto it by piezo printing/laser printer method before the 3d formatting. After this, the vacuum coating step 66 can be performed.

FIG. 6 presents the manufacture of certain hologram types 61, which in some applications requires a manufacturing technology different from the ones described above.

A so-called full hologram has been produced by laser directly to the workpiece only after it is in the 3d form, and no physical processing is directed to the workpiece, which would harm the hologram.

It is not essential for the invention how the different types of holograms are formed, but in what order they are made in different work processes, such as a full hologram, which is only one form of the hologram applications.

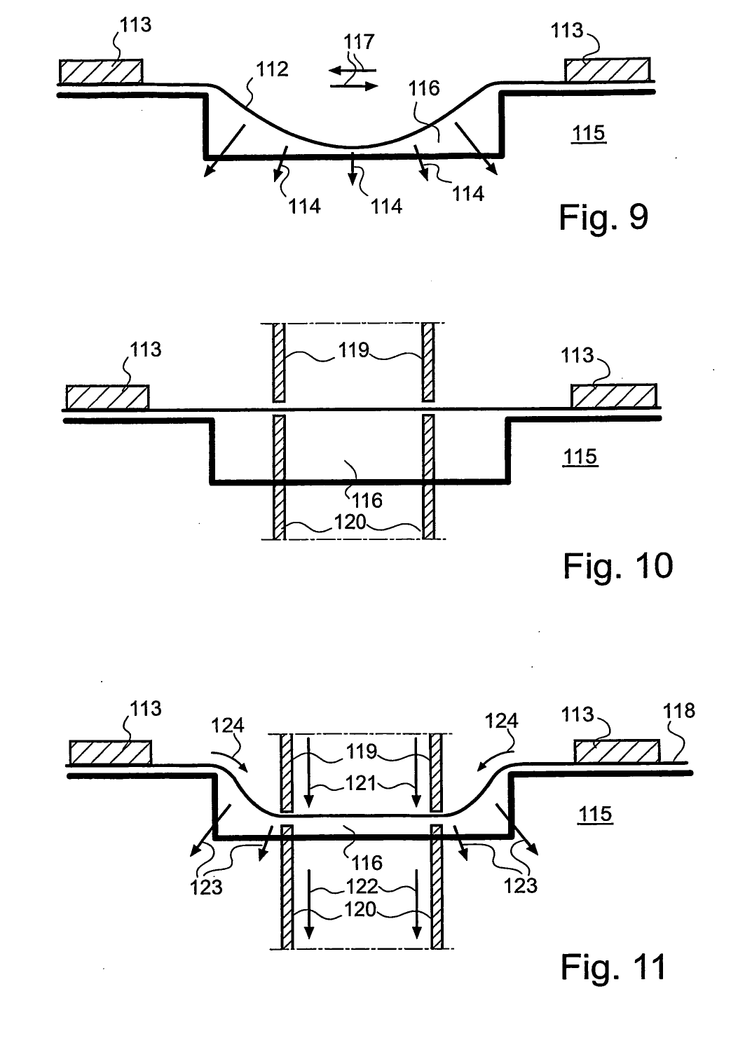

The alignment of the IM film is disclosed in FIGS. 9-13.

The use of the IM film has some typical problematic points, in which the use of special effects and their stability also after the 3d formatting have been solved. Especially the positioning of the IM film and possible further processes for solving this problem will be handled next.

FIG. 9 shows the present practice, in which the IM film 112 has been pressed from its edges between the mould body 115 and the press frame 113. After the IM film 112 has been sufficiently heated, underpressure will be generated by the suction holes 114 in the mould nest 116 so that the IM film 112 will be shaped against the walls of the mould nest 116.

The primary problem is how to make the warm IM film 112 to settle exactly to the desired point. This is naturally difficult, because the IM film 112 is very soft, due to the heat, which again is mandatory, because otherwise the 3d formatting would be impossible.

The IM film 112 moves 117 uncontrollably in the 3d formatting step, and the image surface will not settle to the required point. The transition can even be several millimetres.

The colochrome method presents a solution, which essentially improves the alignment of the IM film in the 3d formatting step. This has been shown in FIGS. 10 and 11.

The basic solution presented in FIG. 10 is principally the same as the one disclosed in FIG. 9. The IM film 118 has been placed under compression between the mould surface 115 and the press frame 113, but with the substantial difference that the IM film 118 is mechanically controlled on the control surfaces 119 and 120, between which the IM film 118 has been placed.

FIG. 11 shows how the IM film 118, which is pressed between the control surfaces 119 and 120, moves synchronously downwards 121, 122 at the same time as underpressure 123 is generated in the nest 116. In this case, the elongation 124 in the formatting of the IM film 118 can be controlled in a very precise manner, because the IM film 118 cannot move uncontrollably any longer, as is the case in the known applications.

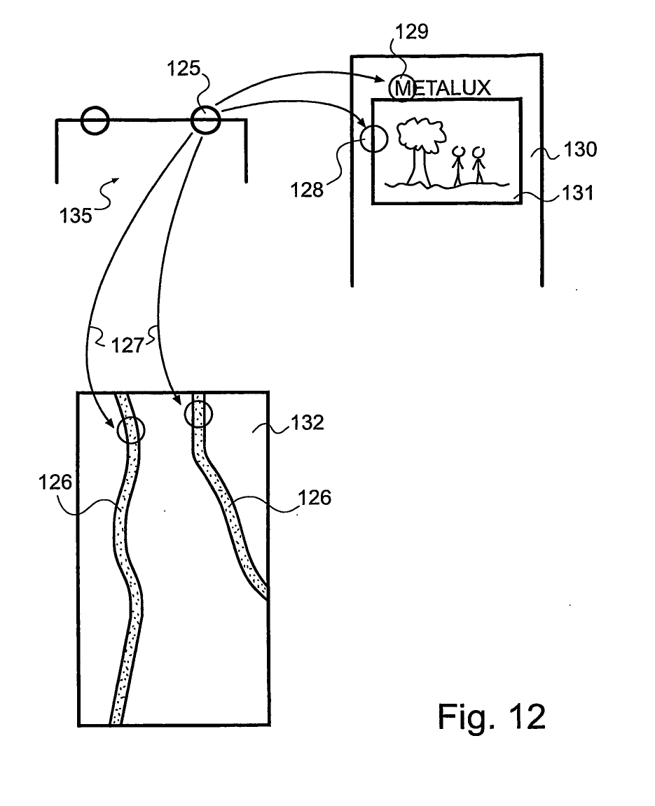

FIG. 12 shows some typical surfaces and areas 125, 127, 128, 129, in which the precise alignment of the IM film is necessary, e.g. texts and images 129, geometrical surfaces 126, the interface between the lens 131 and the cover part 130, etc.

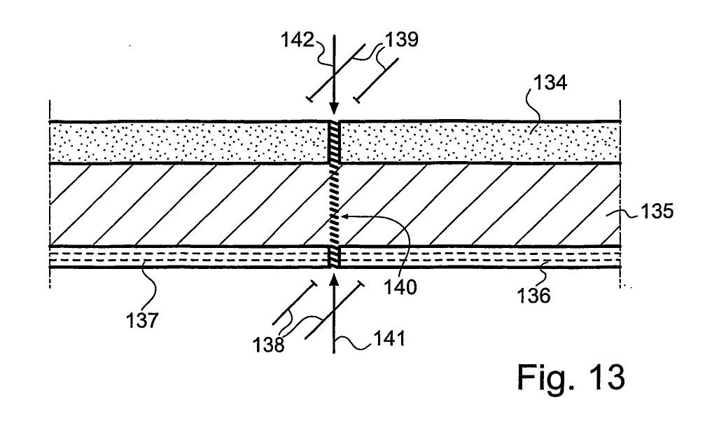

FIG. 13 presents a technology, which can be applied in a colochrome method and which at best can be realised after the injection moulding process. The workpiece has then reached its final shape. The protective surface 134, e.g. UV lacquer, paint, etc. has been formed onto the IM film 135. For example, printing 136 of a geometrical surface has been performed onto the inner surface of the IM film 135, which abuts the second clear surface 137, in which it is possible that the IM film 135 has “moved” in the 3d formatting step and that the interfaces do not meet in the right places. The transition 138 and 139 can still be disturbing. But measures can be performed very precisely by using a laser, e.g. with an accuracy of 1/1000 mm e.g. by forming a hologram, e.g. in form of a file, or make an engraving, processing of the material in any shown point 134, 135, 136, 137 of the surface, also inside 140 the materials, expressly by means of laser 141 and 142 from either direction.

The intention is to use the shown level of technology to fade inaccuracies by forming a precise new interface.

1. Method for manufacturing injection-moulded plastic products, in which method an IM film is used, which travels continuously through several steps known as such, in which the IM film is processed so that a desired image, text or other such desired design can be achieved onto it, characterised in that the processed IM film is directed to the injection moulding process, in which the product and the IM film are combined, after which the combination is transferred to a platform or, for example, directly to the assembly line of mobile phones in an integrated upgrading system.

2. Method according to claim 1, in which plastic products are manufactured, for example, for the following devices: mobile phones, game consoles, press buttons, keyboards, sockets, wrist watches, clocks in general, suitcases, attached cases, document cases, trays, sports equipment, such as frisbee, skateboard, snowboard, consumer goods in general, furnishing parts for cars, furnishing parts for aeroplanes, characterised in that the different work processes have been combined as an integrated part to the injection moulding process and that all steps have been synchronised with each other.

3. Method according to claim 1, characterised in that the steps comprise, among others, the piezo printing/laser printing method, laser engraving method, the hardening method of UV colour/paint, vacuum methods, deep drawing or some other formatting method of the IM film, injection moulding method, vacuum metal-lisation, laser cutting, painting/lacquering with piezo sprays.

4. Method according to claim 1, characterised in that all work processes are digitally controllable.

5. Method according to claim 1, characterised in that the design and formation of the image, surface is conducted digitally.

6. Method according to claim 1, characterised in that the manufacture and all the work processes are directly controllable by means of the Internet.

7. Method according to claim 1, characterised in that the IM film is clean.

8. Method according to claim 1, characterised in that the IM film is continuous and that it simultaneously forms a conveyor.

9. Method according to claim 1, in which the deep drawing or overpressure process is used in the 3d formatting, characterised in that the IM film is directed, aligned on mechanically moving auxiliary surfaces/planes.

10. Method according to claim 1, characterised in that the IM film is formatted before the injection moulding step and that the vacuum processes are directed to a finished 3d formatted IM film before the injection moulding process.

11. Method according to claim 1, in which vacuum metallisation has been combined to the production process e.g. for screening, characterised in that the work process is performed to the inner surface of the workpiece after the injection moulding process.

12. Method according to claim 1, characterised in that the removal/detachment of the workpiece from the IM film, which forms the conveyor as the end of all work processes, is conducted by a laser work process.

13. Method according to claim 1, characterised in that the workpiece is detached from the IM film part by a laser method, and that the work-piece has been placed to a work plane, which is at least biaxial x, y or triaxial x, y,z so that the laser beam would always align correctly.

14. Method according to claim 2, characterised in that the steps comprise, among others, the piezo printing/laser printing method, laser engraving method, the hardening method of UV colour/paint, vacuum methods, deep drawing or some other formatting method of the IM film, injection moulding method, vacuum metallisation, laser cutting, painting/lacquering with piezo sprays.
